(19) United States
(12) Patent Application Publication
(10) Pub. No.: US 2016/0098904 A1
(43) Pub. Date: Apr. 7, 2016

(54) DISTRIBUTED CURRENCY DISPENSING ACROSS AUTOMATED TELLER MACHINE NETWORKS

(71) Applicant: Bank of America Corporation, Charlotte, NC (US)

(72) Inventors: Debashis Choudhury, Dallas, TX (US); Michelle Bentubo, Orlando, FL (US); Maxim Matvienko, Boca Raton, FL (US)

(21) Appl. No.: 14/508,528

(22) Filed: Oct. 7, 2014

(51) Int. Cl. G07F 19/00; G06Q 20/10

(52) U.S. Cl. CPC G07F 19/203; G06Q 40/02; G06Q 20/1085

(57) ABSTRACT

Apparatus and methods for distributed currency dispensing across automated teller machine (“ATM”) networks are provided. In response to a malfunction component of an ATM, a customer may be directed to continue a banking transaction at another location. The other location may include a neighboring ATM. The other location may include a shared resource located within a banking center. The shared resource may perform a function of the malfunctioning ATM component. A shared resource may be accessible by a teller workstation, a platform area workstation or any suitable transaction station within a banking center.

### FIELD OF TECHNOLOGY

Aspects of the disclosure relate to providing apparatus and methods for dispensing cash in a de-centralized and distributed manner using a network of automated teller machines (“ATMs”).

### BACKGROUND

Large financial institutions, such as banks, may provide various methods and tools for customers to perform banking transactions. For example, a bank may provide “brick and mortar” banking centers. The banking centers may be staffed by bank employees. The employees may perform banking transactions requested by bank customers. However, banking centers may only be open during limited hours. For example, a banking center may not be open between 9 PM and 6 AM.

To service customers when a banking center is typically closed, banks have deployed networks of ATMs. An ATM may be accessed by a customer at any time. Additionally, ATMs may perform banking transactions more efficiently than other methods or tools. ATMs may be utilized by banking customers to make deposits, perform balance transfers and withdraw currency among other banking transactions. Requests for currency may include requests for paper bills and/or coins.

Some of the banking transactions performed by ATMs may require specialized machinery. For example, to allow a customer to make a deposit, the ATM may be equipped with an acceptor. The acceptor draws an item presented by the customer into the ATM. The ATM may also include a scanner that generates a digital image of the deposited item. As a further example, an ATM may be equipped with a dispenser. The dispenser may present currency to a customer in response to a withdrawal request. A currency dispenser may be configured to dispense paper bills and/or coins.

An ATM may be available any time a customer wishes. However, use of an ATM is dependent on functionality of ATM components. For example, if a cash dispenser is malfunctioning, a customer may be unable to withdrawn cash. If an acceptor is malfunctioning, a customer may be unable to deposit checks at the ATM.

Typically, if an ATM component is malfunctioning, the ATM may display a message informing potential customers that one or more banking transactions may not be performed using the ATM. In some situations, a customer may wish to perform a banking transaction that does not require use of the malfunctioning ATM component. However, in other situations, customers may not notice the message displayed by the ATM. Therefore it would be desirable to enable a customer to perform any banking transaction despite a malfunctioning ATM component.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 shows an illustrative apparatus in accordance with the principles of the invention;

FIG. 2 shows an illustrative apparatus in accordance with the principles of the invention;

FIG. 3 shows an illustrative system architecture in accordance with the principles of the invention;

FIG. 4 shows illustrative apparatus in accordance with the principles of the invention;

FIG. 5 shows illustrative apparatus in accordance with the principles of the invention;

FIG. 6 shows illustrative apparatus in accordance with the principles of the invention;

FIG. 7 shows illustrative apparatus in accordance with the principles of the invention;

FIG. 8 shows illustrative apparatus in accordance with the principles of the invention;

FIG. 9 shows an illustrative scenario in accordance with the principles of the invention; and

FIGS. 10A, 10B and 10C show an illustrative scenario in accordance with the principles of the invention.

### DETAILED DESCRIPTION OF THE DISCLOSURE

Apparatus and methods for a distributed currency dispensing system are provided. The system may be deployed within a banking center location. The system may include a transaction station. The transaction station may be positioned at a first location within the banking center. The transaction station may be a terminal such as a tablet computer. The transaction station may be configured to authenticate a customer. The transaction station may be configured to receive an instruction from a customer to initiate and/or execute a banking transaction. The instruction may include a request to perform a desired banking transaction.

For example, the transaction station may be equipped with a card reader and keypad. A customer may swipe a bank card using the card reader and enter a personal identification number (“PIN”) using the keypad. The customer may be authenticated based on information encoded on the bank card and the PIN. The transaction station may transmit the authentication information to a computer server. Based on the authentication information, the computer server may locate a banking profile associated with the customer.

The banking profile may indicate whether the customer is commercial or individual, bank accounts, credit card accounts, investment accounts or any other product/service that may be associated with the customer. Based on the banking profile, the customer may be presented one or more banking transactions that may be initialized at the transaction station. The customer may initiate a banking transaction by selecting one or more of the banking transactions presented at the transaction station.

Banking transactions may include money transfers, withdrawals, deposits, account balance checks or any other suitable transaction. However, the transaction station may not include components for making a withdrawal or deposit. The transaction station may only include components for performing banking transactions that do not require handling of paper items such as paper bills or checks.

Transaction stations may include their own components for handling paper items. A portion of the plurality of transaction stations may not include components for handling paper items. The transaction stations that do not include components for handling paper items may utilize a shared resource to handle the paper items. A shared resource may include a shared cash dispenser/recycler, a quick service terminal (“QST”), a check MICR/image scanner, a receipt/valuator printer, a printer/MICR printer, a screen and/or any other suitable devices for implementing a banking transaction.

A QST may include a card swipe reader, a numeric input keypad or any other suitable device. Permissions to access the QST may be provided to customers in response to initiating a banking transaction. Usage of a QST device may be restricted. For example, a QST may only respond to a bank employee or a customer who has initiated a banking transaction. The QST may not be responsive to a customer that has not initiated a banking transaction at a transaction station.

A shared resource, such as a cash recycler, may be the only resource of its kind located within the banking center.

A shared resource for performing banking transactions that require a handling of paper items may be stationed at a second location spaced away from the transaction station. The shared resource at the second location may be accessible to a plurality of transaction stations.

A computer server may be configured to determine whether a banking transaction requested by a customer requires use of a shared resource at a second location within the banking center. A computer server may be configured to determine whether a transaction station accessed by the customer includes components for handling paper items.

When a requested banking transaction does not require use of the shared resource, the computer server may transmit instructions to the transaction station. The instructions may configure the transaction station to complete a requested banking transaction.

When the banking transaction requires use of a shared resource, such as a shared cash recycler, and the transaction station accessed by the customer does not include a cash recycler, the instructions may configure the transaction station to direct the customer to a shared cash recycler. The instructions may configure the shared cash resource to complete the banking transaction initiated at the transaction station.

For example, the instructions may allow the customer to activate the shared resource by presenting authentication information at a QST associated with the shared resource.

The transaction station or tablet at the first location may be one of a plurality of transaction stations. Each of the plurality of stations may be configured to access a shared cash recycler. The plurality of transaction stations may be dispersed throughout a banking center.

Multiple transaction stations may increase an efficiency of the banking center. Customers who initiate banking transactions that do not require handling of paper items may complete their transactions using one of the tablets. Other customers who initiate banking transactions that require handling of paper items may be routed to a shared resource to complete the banking transaction. A presence of a shared resource within the banking center may allow transaction stations to be used for relatively efficient electronic banking transactions. The shared resource may be used for the relatively less-efficient transactions that require a handling of paper items.

A computer server may be configured to receive a plurality of transactions initiated at one or more of the transaction stations. Each of the plurality of transactions may require use of a shared resource. For example, each of the transactions may include a request for a cash withdrawal. A computer server may configure a shared cash recycler to complete each of the plurality of requested withdrawals.

A shared resource such as a cash recycler may include one or more QSTs. For example, a shared cash recycler may include a card reader and a keypad. The shared cash recycler may be configured to identify a banking transaction initiated by a customer using a transaction station. The shared resource may identify the banking transaction based on extracting information from a bank card swiped through the card reader and a PIN input using the keypad. Information encoded on the bank card and the PIN may uniquely identify a customer and/or a record of banking transactions initiated by the customer.

A shared resource, such as a cash recycler, may be configured to complete a banking transaction initiated at a transaction station. The transaction station may be located within a lobby of the banking center. A shared resource may be configured to complete a banking transaction initiated at a teller station. A shared cash recycler may be configured to complete a banking transaction initiated using a customer's mobile device. A shared cash recycler may be configured to complete a banking transaction initiated at any suitable location. A shared resource may be configured to complete a banking transaction initiated by a customer or an employee of the banking center.

Apparatus for a distributed currency dispensing system are provided. The system may include a first ATM located in or on the premises of the banking center. The first ATM may be configured to receive a request to perform a banking transaction. The banking transaction may require an ATM component that handles paper items. For example, the customer may access a first ATM within the banking center and request a cash withdrawal.

The first ATM may determine an availability or operability of a cash dispenser within the first ATM. For example, the customer may not have noticed that the ATM included a message that the first ATM is unable to dispense cash. In some embodiments, the component of the first ATM that dispenses cash may fail after the customer accesses the first ATM.

When the cash dispenser within the first ATM is operational, the cash dispenser may be used to complete the banking transaction requested by the customer. The cash dispenser may transfer cash from the first ATM to the customer.

A cash dispenser within the first ATM may be malfunctioning or otherwise unable to perform a function requested by the customer. The system may be configured to determine an availability of a second cash dispenser within a second ATM. The second ATM may be located in the banking center. The second ATM may be located on the premises of the banking center. For example, the first ATM may be located within a lobby of the banking center. The second ATM may be located on an exterior of a building that houses the banking center.

The first ATM may direct the customer to the second ATM. For example, the first ATM may display a message instructing the customer to proceed to the second ATM. The first ATM may display a location of the second ATM within the banking center. The second ATM may transfer cash or otherwise complete the customer's transaction using the component of the second ATM.

Within a banking center, two or more ATMs may be arranged in a row or tier. In some embodiments, the banking system may only direct the customer to a second ATM when the second ATM is located within the same row or tier of ATMs as the first ATM. ATMs within the same row or tier may typically be in close proximity to each other. Directing a customer to an ATM within the same row or tier may minimize an inconvenience of having to complete a banking transaction at a second ATM.

A first ATM may be further configured to receive, from the customer within the banking center, a request to deposit a check. The first ATM may determine an availability of a deposit acceptor within the first ATM. When the deposit acceptor within the first ATM is available, the first ATM may complete the customer's request by drawing the check into the first ATM using the first deposit acceptor.

When the deposit acceptor within the first ATM is malfunctioning, the banking system may be configured to determine an availability of a second deposit acceptor within a second ATM located in the banking center. When the deposit acceptor within the second ATM is available, the first ATM may direct the customer to the second ATM. A deposit acceptor or any other ATM component may be “available” when the component is functional and not currently in use by another customer.

When the deposit acceptor within the second ATM is available, the customer may deposit the check using the second deposit acceptor of the second ATM.

The first ATM may be further configured to determine an availability of a first receipt printer within the first ATM. When the first receipt printer within the first ATM is available, the first ATM may print a receipt for a banking transaction completed using the first deposit acceptor. When the receipt printer within the first ATM is malfunctioning or otherwise unavailable, the system may determine an availability of a receipt printer within a second ATM. The banking system may configure the first ATM to direct the customer to the second ATM. The banking system may configure the second ATM to print the transaction receipt using the receipt printer of the second ATM.

The customer may be required to provide authentication information at the second ATM. The authentication may include a card swipe and entry of a PIN using one or more QSTs of the second ATM. The authentication of the customer may allow the system to retrieve a record the banking transaction initiated by the customer at the first ATM. The record may indicate what function the second ATM must perform to the complete the customer's transaction.

The first ATM may be further configured to transmit, to the second ATM, transaction information entered by the customer using the first ATM. The transaction information may allow the second ATM to seamlessly continue the banking transaction initiated by the customer at the first ATM.

A customer may be a first customer. In some embodiments, after the system determines that a component of the second ATM is available, the system may prevent a second customer from accessing the second ATM. The system may be further configured to detect a presence of a second customer at the second ATM. The second customer may access the second ATM before the first customer is authenticated at the second ATM. The second customer may have accessed the second ATM after the system determined that a component of the second ATM is available.

In response to detecting a presence of the second customer at the second ATM, the system may determine an availability of a cash dispenser within a third ATM at the banking center. The system may direct the first customer to withdraw cash using the cash dispenser of the third ATM.

In some embodiments, the system may instruct the first customer to access any available ATM within the banking center. In response to an authentication of the first customer at the available ATM, the system may determine that the transaction initiated at the first ATM has not yet been completed. The system may configure the available ATM to prompt the first customer to complete the transaction initiated at the first ATM.

In some embodiments, the first malfunctioning ATM may prompt the customer to select an ATM to complete the banking transaction initiated at the first ATM. In response to the customer selection, the first ATM may display directions to the selected ATM. For example, the first ATM may display a floor plan of a banking center. The selected ATM may be highlighted on the displayed floor plan.

When a component of the first ATM is malfunctioning, the first ATM may display instructions that direct the customer to a second ATM. The second ATM may be configured to display an invitation to the customer to use the second cash dispenser. The invitation may allow a first customer to locate the second ATM that will complete the banking transaction initiated at the first ATM. The invitation may prevent a second customer from accessing the second ATM before the first customer completes the banking transaction initiated at the first ATM.

When a cash dispenser within the first ATM is malfunctioning, the banking system may be configured to direct the customer to the second ATM within a five-foot radius (or any other suitable distance) from the first ATM. The system may complete the banking transaction using the resource within the second ATM.

In some embodiments, when the second ATM is within a five-foot radius of the first ATM, the banking system may prompt the customer to withdraw cash using the second ATM without authenticating the customer at the second ATM. For example, the customer may be directed to reach over to take the cash from a neighboring ATM. In some embodiments, when the second ATM is outside a five-foot radius of the first ATM, the banking system may cancel the customers banking transaction.

Methods for distributed currency dispensing across automated teller machine networks are provided. Methods may include receiving a request to perform a banking transaction. The banking transaction may require a handling of paper items. For example, the banking transaction may include a request to withdraw cash from a first ATM.

Methods may include determining whether a first cash dispenser within the first ATM is operational. When the first cash dispenser is operational, methods may include dispensing cash to the customer using the first cash dispenser. When the first cash dispenser is malfunctioning, methods may include identifying a second ATM within the banking center.

Methods may include, using the first ATM, directing the customer to the second ATM. For example, a message may be displayed to the customer on a screen of the first ATM. As a further example, the second ATM may display a blinking or flashing screen or lights to attract the attention of customer. Methods may include, using the first ATM, transmitting the request of the customer to the second ATM. Methods may include, using the second ATM, dispensing the amount of cash requested by the customer using a second cash dispenser within the second ATM.

Methods may include displaying information on the second ATM. The information may include an invitation for the customer to retrieve the requested amount of cash from the second cash dispenser. The information may include a name of the customer or other suitable information that directs the customer to the second ATM.

The customer may be required to perform authentication at the second ATM before the requested amount of cash is dispensed. In response to authentication of the customer at the second ATM, methods may include dispensing cash to the customer using the second cash dispenser.

One of ordinary skill in the art will appreciate that the steps shown and described herein may be performed in other than the recited order and that one or more steps illustrated may be optional. The methods of the above-referenced embodiments may involve the use of any suitable elements, steps, computer-executable instructions, or computer-readable data structures. In this regard, other embodiments are disclosed herein as well that can be partially or wholly implemented on a computer-readable medium, for example, by storing computer-executable instructions or modules or by utilizing computer-readable data structures.

Illustrative embodiments of apparatus and methods in accordance with the principles of the invention will now be described with reference to the accompanying drawings, which form a part hereof. It is to be understood that other embodiments may be utilized and that structural, functional and procedural modifications may be made without departing from the scope and spirit of the present invention. Methods of the above-referenced embodiments may involve the use of any combination of methods, portions of methods, partially executed methods, elements, one or more steps, computer-executable instructions, or computer-readable data structures disclosed herein.

As will be appreciated by one of skill in the art, the invention described herein may be embodied in whole or in part as a method, a data processing system, or a computer program product. Accordingly, the invention may take the form of an entirely hardware embodiment, an entirely software embodiment or an embodiment combining software, hardware and any other suitable approach or apparatus.

Furthermore, such aspects may take the form of a computer program product stored by one or more computer-readable storage media having computer-readable program code, or instructions, embodied in or on the storage media. Any suitable computer readable storage media may be utilized, including hard disks, CD-ROMs, optical storage devices, magnetic storage devices, and/or any combination thereof. In addition, various signals representing data or events as described herein may be transferred between a source and a destination in the form of electromagnetic waves traveling through signal-conducting media such as metal wires, optical fibers, and/or wireless transmission media (e.g., air and/or space).

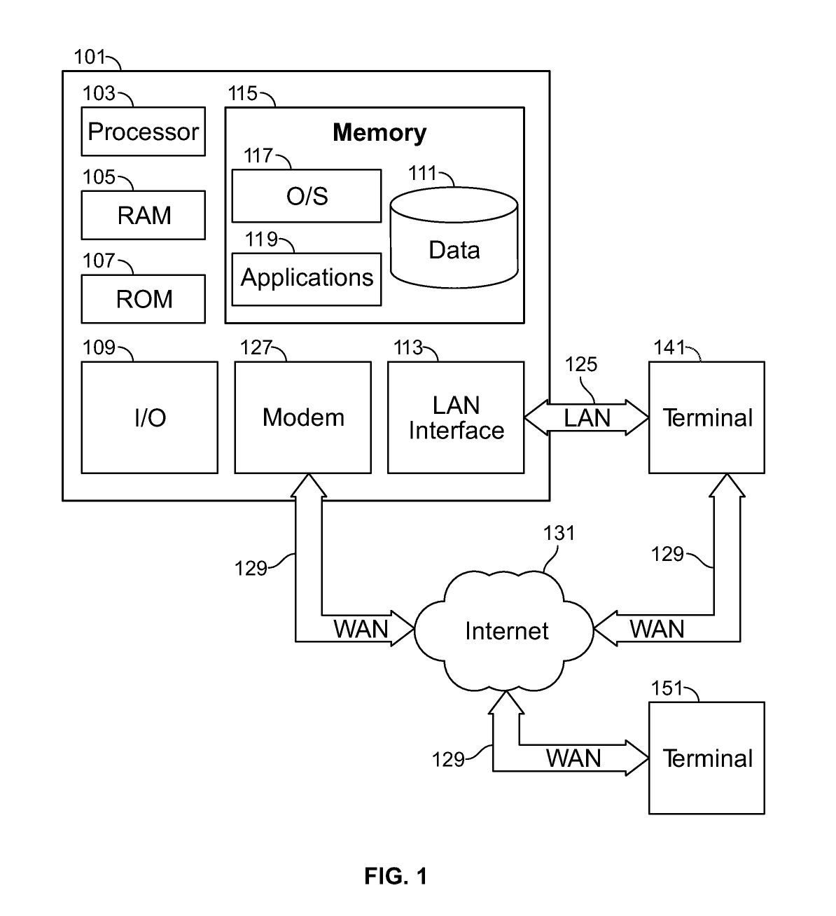

FIG. 1 is a block diagram that illustrates a computing device 101 (alternatively referred to herein as a “server or computer”) that may be used according to an illustrative embodiment of the invention. The computer server 101 may have a processor 103 for controlling overall operation of the server and its associated components, including RAM 105, ROM 107, input/output (“I/O”) module 109, and memory 115.

I/O module 109 may include a microphone, keypad, touch screen and/or stylus through which a user of device 101 may provide input, and may also include one or more of a speaker for providing audio output and a video display device for providing textual, audiovisual and/or graphical output. Software may be stored within memory 115 and/or other storage (not shown) to provide instructions to processor 103 for enabling server 101 to perform various functions. For example, memory 115 may store software used by server 101, such as an operating system 117, application programs 119, and an associated database 111. Alternatively, some or all of computer executable instructions of server 101 may be embodied in hardware or firmware (not shown).

Server 101 may operate in a networked environment supporting connections to one or more remote computers, such as terminals 141 and 151. Terminals 141 and 151 may be personal computers or servers that include many or all of the elements described above relative to server 101. The network connections depicted in FIG. 1 include a local area network (LAN) 125 and a wide area network (WAN) 129, but may also include other networks. When used in a LAN networking environment, computer 101 is connected to LAN 125 through a network interface or adapter 113. When used in a WAN networking environment, server 101 may include a modem 127 or other means for establishing communications over WAN 129, such as Internet 131.

For example, ATMs may receive and/or transmit banking transaction information to a remote server over a WAN or LAN. The remote server may track a progress of the banking transaction. In the event that a first ATM in unable to complete the banking transaction, the remote server may transmit a current state of the banking transaction to a second ATM. The customer may be invited to move from the first ATM and complete the banking transaction at the second ATM.

It will be appreciated that the network connections shown are illustrative and other means of establishing a communications link between the computers may be used. The existence of any of various well-known protocols such as TCP/IP, Ethernet, FTP, HTTP and the like is presumed, and the system can be operated in a client-server configuration to permit a user to retrieve web pages from a web-based server. Any of various conventional web browsers can be used to display and manipulate data on web pages.

Additionally, application program 119, which may be used by server 101, may include computer executable instructions for invoking user functionality related to communication, such as email, short message service (SMS), and voice input and speech recognition applications.

Computing device 101 and/or terminals 141 or 151 may also be mobile terminals including various other components, such as a battery, speaker, and antennas (not shown). Terminal 151 and/or terminal 141 may be portable devices such as a laptop, tablet, smartphone or any other suitable device for receiving, storing, transmitting and/or displaying relevant information.

Any information described above in connection with database 111, and any other suitable information, may be stored in memory 115. One or more of applications 119 may include one or more algorithms that may be used to instruct ATMs, identify operational and malfunctioning ATM components, process banking transactions, track a progress of a banking transaction, configure shared resources or any other suitable tasks.

The invention may be operational with numerous other general purpose or special purpose computing system environments or configurations. Examples of well-known computing systems, environments, and/or configurations that may be suitable for use with the invention include, but are not limited to, personal computers, server computers, hand-held or laptop devices, tablets, mobile phones and/or other personal digital assistants (“PDAs”), multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

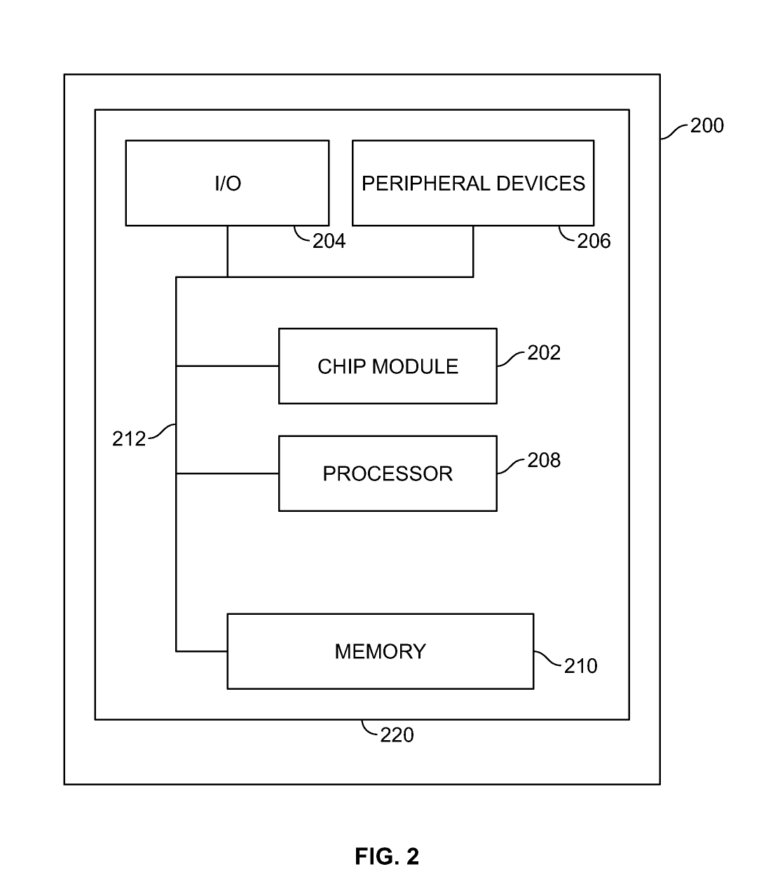

FIG. 2 shows an illustrative apparatus that may be configured in accordance with the principles of the invention.

FIG. 2 shows illustrative apparatus 200. Apparatus 200 may be a computing machine. Apparatus 200 may include one or more features of the apparatus shown in FIG. 1. Apparatus 200 may include chip module 202, which may include one or more integrated circuits, and which may include logic configured to perform any other suitable logical operations.

Apparatus 200 may include one or more of the following components: I/O circuitry 204, which may include a transmitter device and a receiver device and may interface with fiber optic cable, coaxial cable, telephone lines, wireless devices, PHY layer hardware, a keypad/display control device or any other suitable encoded media or devices; peripheral devices 206, which may include counter timers, real-time timers, power-on reset generators or any other suitable peripheral devices; logical processing device 208, which may compute data structural information, structural parameters of the data, quantify indices; and machine-readable memory 210.

Machine-readable memory 210 may be configured to store in machine-readable data structures: customer profiles, banking transactions, computer code and any other suitable information or data structures.

Components 202, 204, 206, 208 and 210 may be coupled together by a system bus or other interconnections 212 and may be present on one or more circuit boards such as 220. In some embodiments, the components may be integrated into a single chip. The chip may be silicon-based.

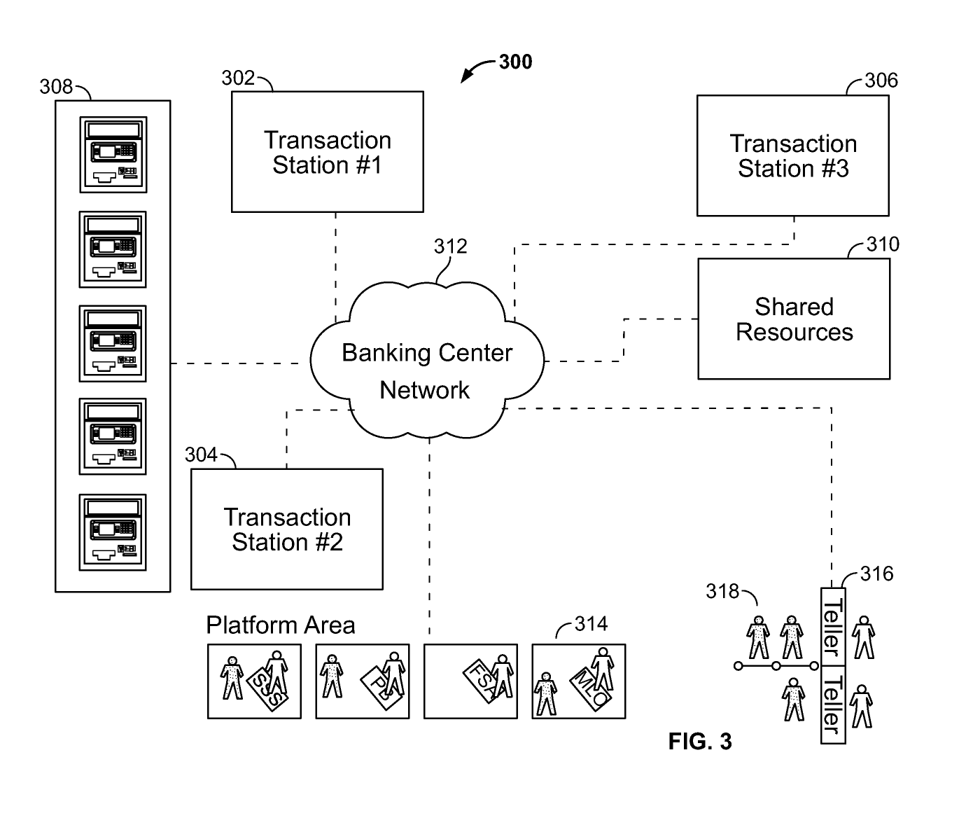

FIG. 3 shows illustrative distributed currency dispensing system 300. System 300 may be deployed within a brick and mortar banking center. System 300 includes ATMs 308. ATMs 308 are arranged in a row or tier. Each of ATMs 308 may access shared resources 310 via banking center network 312. Shared resources 310 may include a cash dispenser/recycler. One or more of ATMs 308 may be included in shared resources 310. Shared resources 310 may receive banking transaction information from ATMs 308.

System 300 includes transaction stations nos. 1-3. Each transaction station may include a tablet that does not include components for handling paper items. To perform a banking transaction that requires handling paper items, a transaction station may access shared resources 310 via banking center network 312.

System 300 includes platform area 314. Platform area 310 may include workstations operated by banking center employees. A customer may utilize platform area 310 for access to products or services available at the banking center. Customers may access platform area 314 to perform banking transactions. Platform area 310 may access shared resources 310 via banking center network 312.

System 300 includes teller workstations 316. Teller workstations 316 may utilize shared resources 310 to perform banking transactions. Teller workstations 316 may access shared resources 310 via banking center network 312. For example, if customer 318 requests a bank check, a banking center employee stationed at teller workstation 316 may authenticate customer 318 by viewing a photo identification presented by customer 318. After authentication, customer 318 may be directed to shared resources 310. Customer 318 may retrieve the requested bank check from a printer included within shared resources 310.

In some embodiments, shared resources 310 may include one or more components of ATMs 308. For example, customer 318 may submit a request for a cash withdrawal at teller workstation 316. Transaction information, such as the amount of cash requested, may be entered using teller workstation 316. After obtaining the required information and authenticating customer 318, customer 318 may be directed to retrieve the requested amount of cash from one of ATMs 308.

Customer 318 may be required to perform authentication at ATMs 308. Because the withdrawal request has already been entered into banking system 300 (e.g., at teller workstation 316 or at transaction stations 302-306), customer 318 may not need to reenter the request after authentication at ATMs 308.

Authentication required at shared resources 310 may be different from authentication performed at a location where the customer initiated the banking transaction. For example, at teller workstation 316, customer 318 may be required to swipe a card. To access shared resources 310, customer 318 may be required to swipe the card and enter a PIN.

In some embodiments, after initiating a banking transaction at teller workstation 316 or transaction station 306, customer 318 may access shared resources 310 with just a card swipe and no PIN entry. Banking system 300 may allow customer 318 to access shared resources 310 with only a card swipe within a pre-determined time interval. The pre-determined time interval may be calculated from a time a banking transaction was initiated at a location within the banking center.

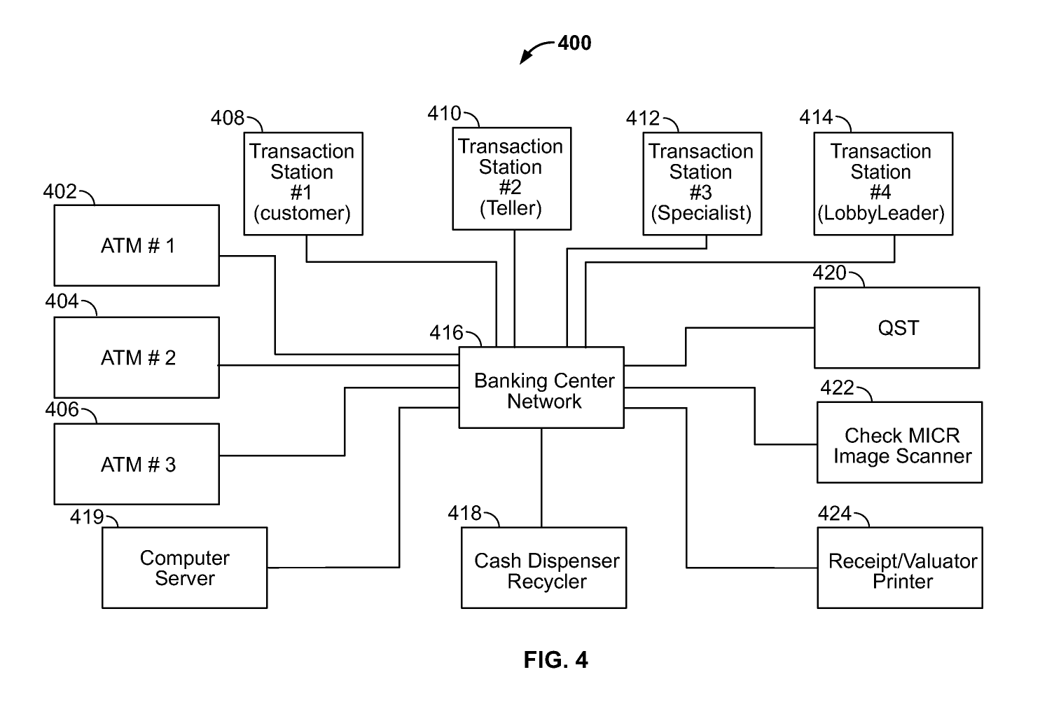

FIG. 4 shows illustrative system architecture 400. Architecture 400 includes banking center network 416. Network 416 may be a local LAN within a banking center. Network 416 allows ATMs 402, 404 and 406 to communicate, directly or indirectly, with exemplary shared devices 418, 420, 422, and 424. Network 416 allows tablet stations 408, 410, 412 and 414 to communicate, directly or indirectly, with the exemplary shared resources. Network 416 connects a teller using tablet station 410 to the exemplary shared resources. Network 416 connects a banking specialist using tablet station 412 to the exemplary shared resources.

A tablet station may be restricted from accessing one or more of the exemplary shared resources. For example, a customer using tablet station 408 or ATM 404 may not be provided access to cash recycler 418 after 5 pm. Cash recycler 418 may be positioned within a banking center location that is off limits to customer after 5 pm.

Network 416 allows a lobby leader using tablet station 414 to access the exemplary shared resources. A lobby leader may advise customers entering the banking center where and how to obtain banking transaction services. For example, a lobby leader may direct a customer to tablet station 408 to perform a banking transaction that does not require handling of paper items. A lobby leader may configure tablet station 408 to show specific menus or banking transaction options desired by the customer. Showing specific information desired by the customer may allow the customer to efficiently obtain desired banking services.

Architecture 400 includes computer server 419. Computer service 419 may process and store information associated with one or more banking transactions. For example, computer server 419 may receive banking transaction information from tablet station 408. Computer server 419 may initiate and store transaction information. Computer server 419 may allow a customer to complete the initiated banking transaction by transmitting stored transaction information to one or more of the exemplary shared resources. Computer server 419 may include one or more features of server 101 (shown in FIG. 1).

Computer server 419 may be configured to manage conflicts among tablet stations competing for use of one or more shared resources. For example, a teller and a customer may both attempt to access a printer using different tablet stations. The computer server may control who gain access to the printer first. Conflict resolution may be adjudicated according to rules. The computer server may store and/or implement the rules.

An exemplary rule may allow a customer initiated banking transaction to proceed before a teller initiated banking transaction. Another rule may allow a banking transaction initiated at an ATM with a malfunctioning component to precede any other banking transaction. A banking transaction initiated at a malfunctioning ATM may be given priority over another banking transaction initiated earlier in time. Another rule may give precedence to a banking transaction initiated at a tablet station operated by a lobby leader. Any suitable rules for conflict resolution may be implemented by computer server 419.

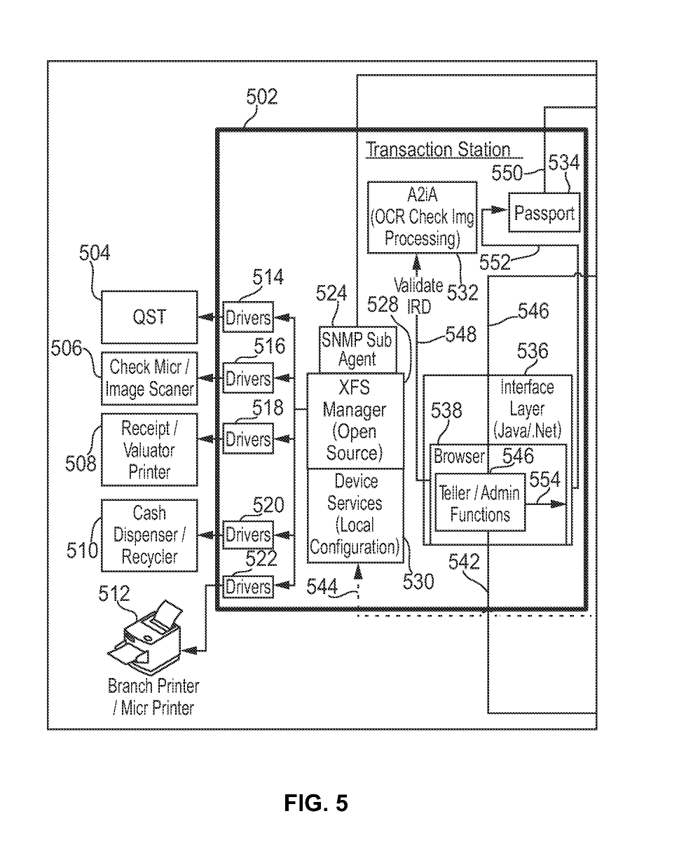

FIG. 5 shows illustrative transaction station 502 with exemplary components. Transaction station 502 is shown in the context of use by a bank teller. Transaction station 502 may be located in a banking center. Transaction station 502 may be used by a teller. The teller may perform a banking transaction for a customer using transaction station 502. Transaction station 502 may include hardware, such as a tablet computer and software.

In some embodiments, transaction station 502 may be a component of an ATM. An ATM may be located at a banking center. An ATM may also be located near a banking center, for example, in a banking center parking lot.

Transaction station 502 may include device services (local configuration) 530. Device services 530 may enable a user of transaction station 502 to use a shared device. Device services (local configuration) may receive information from device application services (not shown) via communication line 544. The received information may give the user access to specific shared devices. The received information may also change the permissions of the user to access specific shared devices.

It should be appreciated that QST 504, magnetic ink character recognition (“MICR”) scanner/image scanner 506, receipt/valuator printer 508, cash dispenser/recycler 510 and branch printer/MICR printer 512 may each be shared devices, which can be accessed by more than one user.

Extensions for financial services (“XFS”) manager 528 may serve as a go-between with drivers 514, 516, 518, 520 and 522, and device services 530. XFS manager may manage the shared devices. XFS manager may also determine how transaction station 502 can and/or should engage with the shared devices.

Device services (local configuration) 530 may communicate with drivers 514, via XFS manager 528. Drivers 514 may provide access to quick service terminal (“QST”) 504. A QST may include a card swipe reader, a numeric input keypad or any other suitable device. Permissions to access the QST may be provided to customers initiating a banking transaction. The device services (local configuration) 530 may allow for access to a QST device. In some embodiments, the device services (local configuration) 530 may restrict usage of the QST device to a user who has initiated a banking transaction.

Device services (local configuration) 530 may also communicate with drivers 516, via XFS manager 528. Drivers 516 may provide access to check MICR/image scanner 506. Permissions to access check MICR/image scanner 506 may be provided to a teller engaged in assisting a customer deposit a check. In certain embodiments, check MICR/image scanner 506 may be found in an ATM.

Device services (local configuration) 530 may also communicate with drivers 518, via XFS manager 528. Drivers 518 may provide access to receipt/valuator printer 508. Permissions to access the receipt/valuator printer 508 may be determined by device services 530. Permission may be given to a teller, or a customer who wishes to print a receipt of a banking transaction. Receipt/valuator printer 508 may also be found in an ATM.

Device services (local configuration) 530 may also communicate with drivers 520, via XFS manager 528. Drivers 520 may provide access to cash dispenser/recycler 510. Permissions to access cash dispenser/recycler 510 may be determined by device services. Permissions may be given to a teller, or customer who may deposit, or withdraw, cash to during a banking transaction.

Device services (local configuration) 530 may also communicate with drivers 522, via XFS manager 528. Drivers 522 may provide access to branch printer/MICR printer 512. Permissions to access branch printer/MICR printer 512 may be determined by device services 530. Permissions may be given to a teller, or a customer, who may print a banking transaction statement.

SNMP (Simple Network Management Protocol) sub agent 524 may be a hardware exception handling protocol. SNMP sub agent may determine or receive notification, when a printer device runs out of paper. SNMP sub agent may also determine or receive notification, when a device jams or a cash dispenser device depleted its cash. SNMP sub agent 524 may communicate with XFS manager 528. SNMP sub agent may also communicate with extended messaging services (“XMS”) (not shown).

Transaction station 502 may also include browser 538. Browser 538 may allow a user to access the internet—e.g., for the purpose of accessing an online banking service. Transaction station 502 may also include teller/admin functions 540. Teller/admin functions 540 may interact with browser 538 via connection 554. Teller/admin functions 540 may also communicate, via communication line 546, with a branch processor (not shown). Teller/admin functions 540 may also communicate with a teller application server via communication line 542.

Interface layer (Java®/.Net) 536 may enable browser 538 to communicate with the internet by providing the necessary protocols. The protocols used to communicate with browser 538 may include Java®. The protocols used to communicate with browser 538 may include the Microsoft® .Net Framework.

Browser 538 may communicate with A2iA® software (Object character recognition (“OCR”) check image processing) 532, via communication line 548. A2iA® software 532 may validate a check. In order for a check to be validated by A2iA® software 532, the check should preferably include the required components of an Image Replacement Document (“IRD”) document. If A2iA® determines that a check includes the required components of an IRD document, the check may be validated.

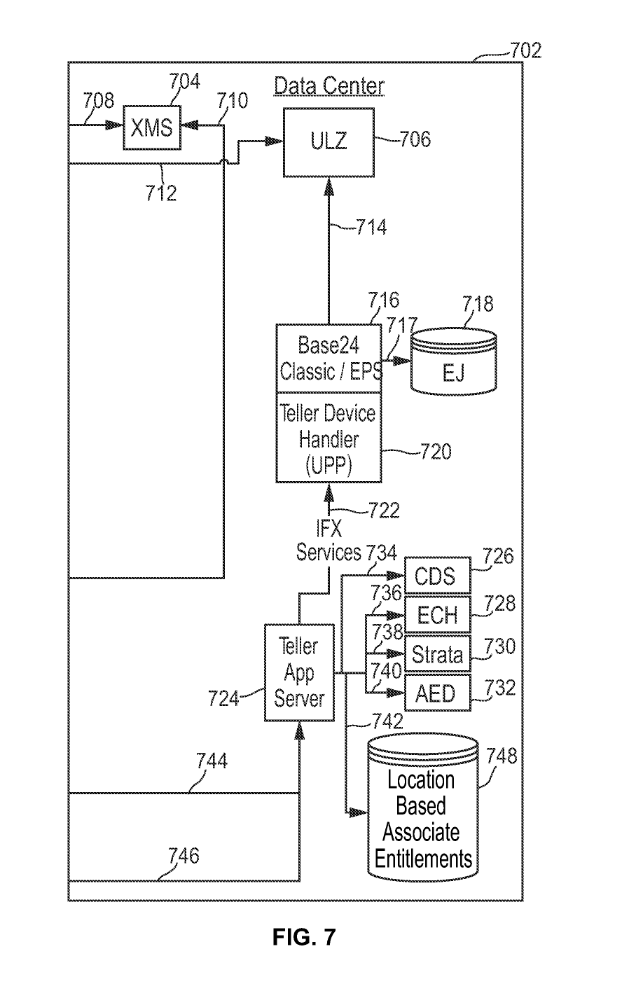

When a check is validated, relevant information may be transmitted to browser 538. The relevant information may then be transferred from browser 538 to interface layer 536. The relevant information may then be transferred from interface layer 536 to passport 534, via communication line 552. Passport 534 may convert the check to an IRD electronic document. Passport 534 may transmit the IRD electronic document to Universal Landing Zone (“ULZ”) such as ULZ 706 (shown in FIG. 7), via communication line 550. Passport 534 may provide a response to interface layer 536 regarding the authorization of the check.

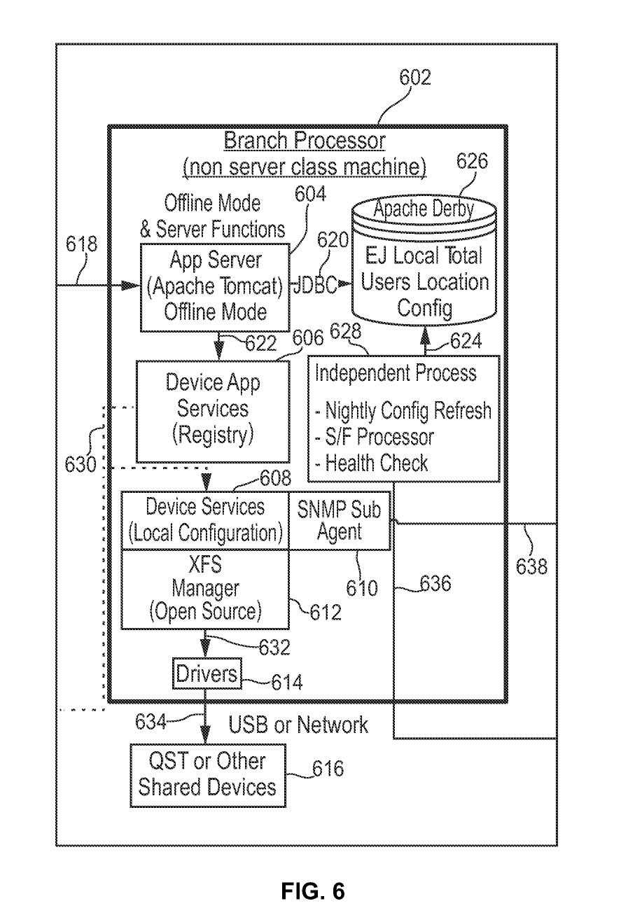

FIG. 6 shows branch processor 602 with exemplary components. Branch processor 602 may include device application services (registry) 606. Device application services (registry) 606 may identify what types of devices are available. Device application services (registry) 606 may also identify what denominations are contained in a shared cash recycler. Device application services (registry) 606 may also identify how many shared devices are available, etc. Device application services (registry) 606 may communicate, via communication line 630, with a device services (local configuration) 608 via communication line 630. XFS manager 612 may be a device manager. XFS manager may act as a go-between between the device services (local configuration) 608 and drivers 614, using communication line 632. Drivers 614 may provide access to QST or other shared devices 616, via communication line 634.

Branch processor 602 may also include SNMP sub agent 610. SNMP sub agent 610 may be a hardware exception handler. SNMP sub agent 610 may communicate with XMS (not shown), via communication line 638.

It should be appreciated that Branch processor 602 includes all the necessary components to execute the tasks performed by a transaction station. These components include device services (local configuration) 608, XFS manager 612, drivers 614 and communication line 634, SNMP sub agent 610 and branch processor 602.

Branch processor 602 may include application server (Apache Tomcat™) offline mode 604. Application server 604 may be a processor which enables branch processor 602 to remain active during service degradation. Application server 604 may have degraded, or offline mode capabilities. These capabilities may include withdrawal of cash, up to a predetermined amount; deposit of checks; and cashing of checks, up to a predetermined amount; and/or any suitable capabilities in degraded mode. Application server 604 may communicate with device application 606, via communication line 622. Application server may receive communications from teller/admin functions (not shown) via communication line 618. Application server 604 may also communicate with Electronic Journal (“EJ”) 626, via protocol Java® database connectivity (“JDBC”) 620.

EJ 626 may record and save substantially all incomplete and completed banking transactions that occur in branch processor 602. The contents of EJ 626 may be transmitted to a data center (not shown) when application server 604 is operated in a degraded mode.

Branch Processor 602 may also include independent process 628. Independent process 628 may monitor the health of the processor 602, as well as perform a nightly configuration refresh. A nightly configuration refresh may cause independent process 628 restart and/or reconfigure processor 602. Independent process 628 may also communicate with EJ 626, via communication line 624. Independent process 628 may also communicate with a teller application server at a data center, such as data center 702 (shown in FIG. 7) via communication line 636.

FIG. 7 shows data center 702 with exemplary components. Data center 702 may include XMS 704. XMS 704 may communicate with SNMP, via communication lines 708 and 710. SNMP, as described above, may be located on a transaction station such as transaction station 502 (shown in FIG. 5) or a branch processor, such as branch processor 602 (shown in FIG. 6). XMS may transmit messages to SNMP located on the branch processor and the desktop application.

Data center 702 may include ULZ 706. ULZ 706 may enable transfer of money between different financial institutions. ULZ may also enable transfer of money within a financial institution. ULZ 706 may receive instructions to transfer money from based on information captured by Passport 534 (show in FIG. 5) and transmitted over communication line 712. ULZ 706 may also receive IRD documents from Passport 534 over communication line 712. Passport 534 may be located on a transaction station 502, as shown in FIG. 5. ULZ may also receive transfer instructions from Base24 Classic/EPS 716 via communication line 714.

Base24 Classic/EPS 716 may be a server. Base24 716 may transmit substantially all steps of initiated banking transactions to EJ 718 via communication line 717. EJ 718 may record and save substantially all steps of banking transactions received. Base24 716 may be connected to Teller Device Handler (Universal Payment Platform (“UPP”)) 720. Financial Messaging Protocol (“IFX”) services 722 may be customized to create a customized IFX device handler. A customized IFX device handler may allow for commercial deposits, dozens of check deposits and degraded server mode.

Using conventional UPP tools, IFX services 722 may be transmitted from teller application server 724. Teller application server 724 may include one or more features of server 101 (shown above in FIG. 1). Teller application server 724 may identify the distribution of cash requested using at substantially all branch processors and transaction stations. Communication lines 744 may link branch processors with teller application server 724. Communication lines 746 may link transaction stations with teller application server 724.

Teller application server 724 may communicate with customer data store (“CDS”) 726 via communication line 734. CDS 726 may include the capabilities to identify account information. The account information may be account information which occurred during a pre-determined time such as business day.

Teller application server 724 may communicate via communication line 736 with ECH 728. ECH 728 may store data for an entire banking center or financial institution. Using ECH 728, the teller application server may identify account data regardless of where the transaction occurred.

Teller application server 724 may communicate via communication line 738 with Strata 730. Strata 730 may store images. Strata 730 may also store images regarding signatures of customers. The saved signatures of customers may be used for verification of customer signatures.

Teller application server 724 may communicate with associate entitlement database (“AED”) 732 via communication line 740. AED 732 may include entitlements and identification of associates.

Teller application server 724 may also communicate with location-based associate entitlements 748 via communication line 742.

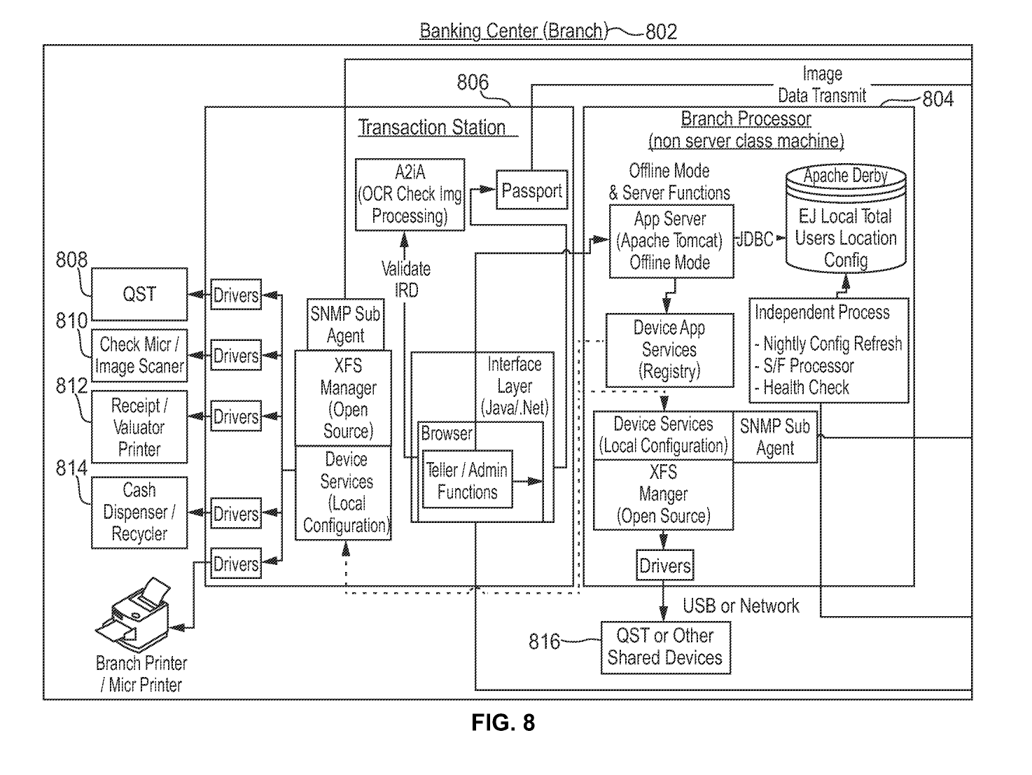

FIG. 8 shows banking center (branch) 802. Banking center (branch) 802 may include branch processor 804. Branch processor 804 may include one or more features of branch processor 602 (shown above in FIG. 6). Banking center (branch) 802 may also include transaction station 806. Banking center (branch) 802 may also include shared devices, including QST 806, check MICR/image scanner 810, receipt/valuator printer 812, cash dispenser/recycler 814 and QST or other shared devices 816. Banking center (branch) 802 may include more than one branch processor. Banking center (branch) 802 may also include more than one transaction station. The shared devices, as described above, may be used by multiple transaction stations and branch processors in a banking center.

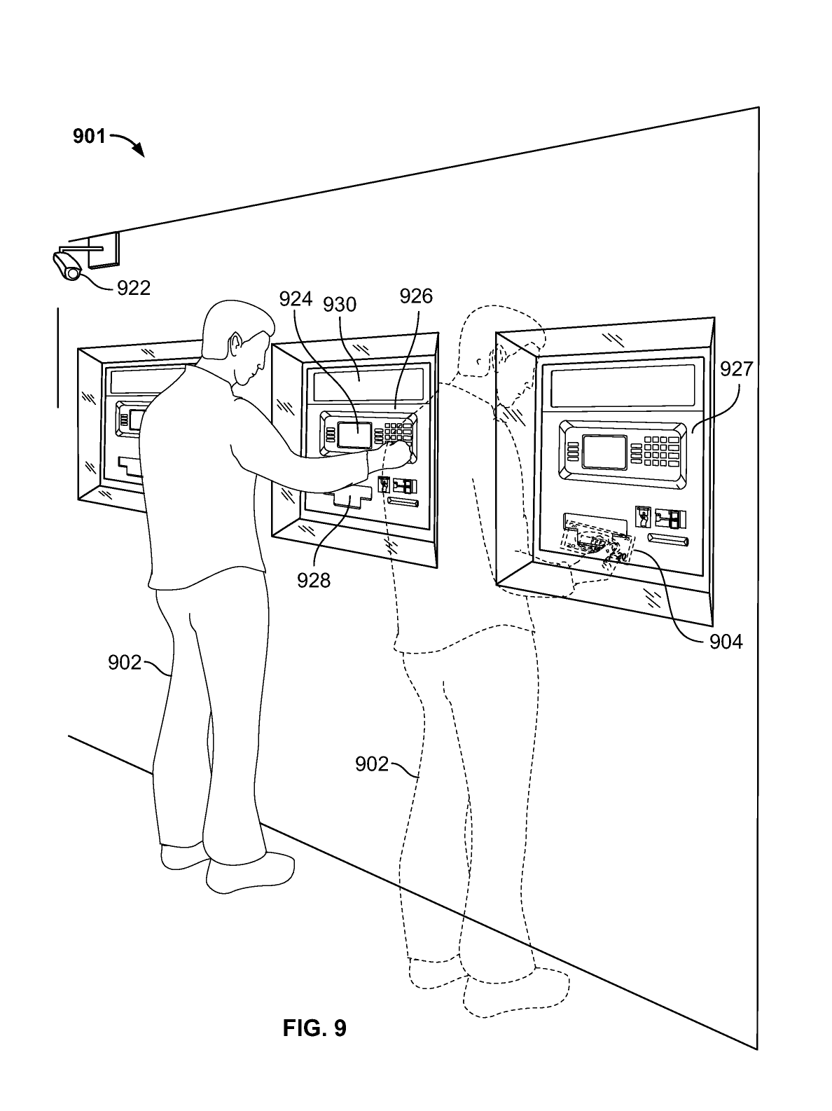

FIG. 9 shows illustrative scenario 901. Scenario 901 shows ATM customer 902 accessing first ATM 926. First ATM 926 may include one or more features of ATMs 308 (shown in FIG. 3) and/or ATMs 402-406 (shown in FIG. 4). Customer 902 may request a withdrawal of cash from ATM 926. Typically, the requested cash may be dispensed to customer 902 via dispenser 928.

Sensor 922 may be oriented to capture one or more actions of customer 902. For example, sensor 122 may capture cash collected by customer 902. Sensor 922 may verify that customer 902 collected cash from ATM 926 or 927.

ATM 926 may include a sensor (not shown) behind screen 930. The sensor behind screen 930 may be oriented to capture one or more characteristics of customer 902. For example, the sensor may capture a biometric feature, such as an iris pattern of customer 902. The information captured by the sensor may authenticate customer 902.

In an illustrative scenario, dispenser 928 of ATM 926 may malfunction. In such a scenario, first ATM 926 may direct customer 902 to retrieve the requested cash from second ATM 927. Second ATM 927 may include one or more features of ATM 926. A message presented on display 924 of first ATM 926 may inform customer 902 to reach over to second ATM 927. First ATM 926 may transmit transaction information entered by customer 902 to a computer server such as computer server 419 (shown in FIG. 4). The computer server may share transaction information entered by customer 902 at first ATM 926 with second ATM 927. Sharing the transaction information with second ATM 927 allows ATM 927 to process a banking transaction initiated at ATM 928 without requiring customer 902 to reenter transaction information.

Scenario 901 shows customer 902 (in broken-line) moving over to second ATM 927 to retrieve cash 904. Cash 904 had been requested by customer 902 using first ATM 926. Allowing customer 902 to use second ATM 927 to complete a transaction initiated using first ATM 926 may reduce any inconvenience or delay as a result of a malfunctioning component within first ATM 926.

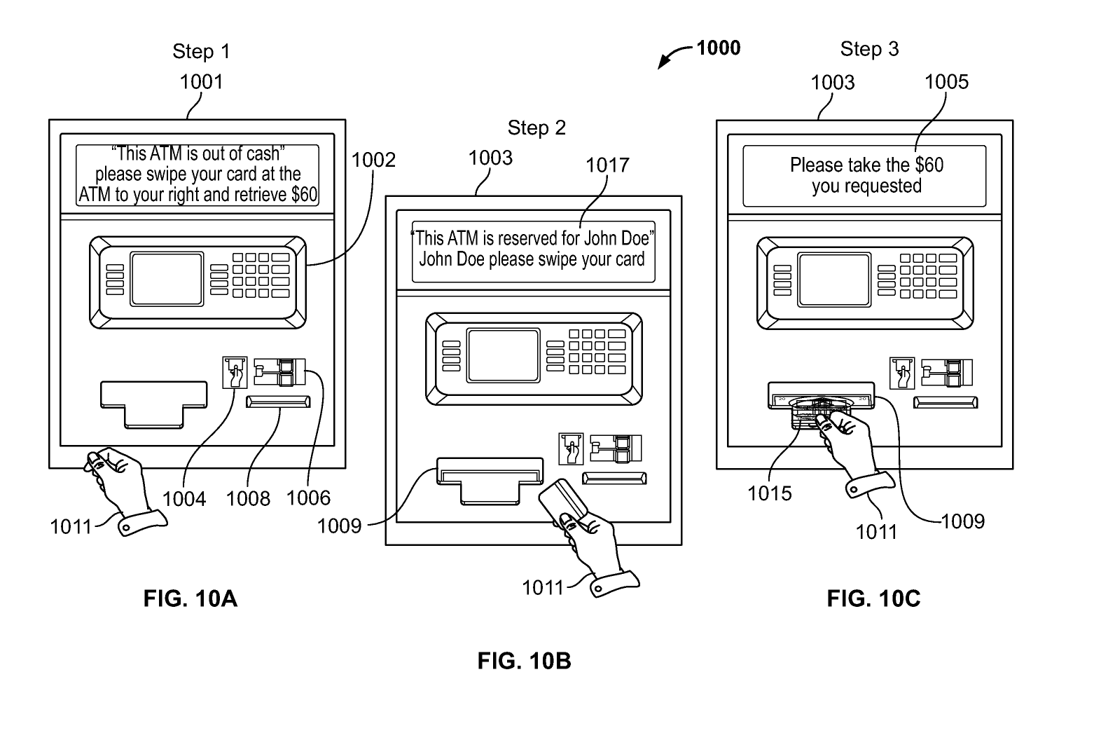

FIGS. 10A-10C show illustrative scenario 1000. Scenario 1000 shows first ATM 1001 informing banking customer 1011 that first ATM 1001 is out of cash. An ATM may run out of cash a result of multiple withdrawals by other customers during the day. Scenario 1000 shows that first ATM 1001 directs customer 1011 to swipe a card at neighboring second ATM 1003. In some embodiments, ATM 1001 may offer customer 1011 an option to continue the transaction using a neighboring ATM or other shared resource. ATM 1001 may also offer customer 1011 the option to cancel the transaction initiated at ATM 1001.

Step 2 of scenario 1000 shows an ATM on the customer's right, second ATM 1003. Second ATM 1003 is shown displaying a message inviting customer 1011 to use second ATM 1003. The message may also discourage other customers from using second ATM 1003 before the customer of first ATM 1001 completes the banking transaction initiated using first ATM 1001. Step 2 also shows customer 1011 inserting a card into second ATM 1003. Customer 1011 may be required to insert the card as a form of authentication to access second ATM 1003.

Step 3 of scenario 1000 shows second ATM 1003 dispensing cash 1015 requested by customer 1011 at first ATM 1001. In some embodiments, if customer 1011 swipes a bank card at second ATM 1003 within a pre-determined time interval, customer 1011 may not be required to enter a PIN for second ATM 1003 to dispense cash 1015 requested at first ATM 1001.

Thus, systems and methods for distributed cash dispensing across automated teller machine networks have been provided. Persons skilled in the art will appreciate that the present invention can be practiced by other than the described embodiments, which are presented for purposes of illustration rather than of limitation. The present invention is limited only by the claims that follow.

What is claimed is:

1. A currency distribution system at a banking center location, the system comprising:
a transaction station at a first location within the banking center that is configured to receive an instruction from a customer to initiate a banking transaction;
a computer server configured to determine whether the banking transaction requires use of a shared cash recycler at a second location within the banking center;
when the banking transaction does not require use of the shared cash recycler, the computer server configures the transaction station to allow the customer to complete the banking transaction using the transaction station; and
when the banking transaction requires use of the shared cash recycler:
the computer server configures the transaction station to direct the customer to the shared cash recycler at the second location; and
the computer server configures the shared cash recycler to complete the banking transaction by dispensing currency requested by the customer at the transaction station.

2. The system of claim 1 wherein:
the transaction station at the first location is one of a plurality of tablet computers; and
each of the plurality of tablet computers is configured to access the shared cash recycler.

3. The system of claim 1 wherein the shared cash recycler comprises a card reader and a keypad;
and the shared cash recycler is configured to identify the banking transaction initiated at the transaction station in response to:
a card swiped through the card reader; and
a four digit code entered using the keypad.

4. The system of claim 1 wherein the shared cash recycler is configured to receive transaction instructions and complete banking transactions initiated at:
the transaction station at the first location within the banking center; and
a teller station at a third location within the banking center.

5. The system of claim 1 wherein the first location is a lobby of the banking center.

6. The system of claim 1 wherein the only cash recycler located within the banking center is the shared cash recycler.

7. The system of claim 1 wherein the shared cash recycler is configured to complete a first transaction initiated by the customer and a second transaction initiated by an employee of the banking center.

8. The system of claim 1 wherein:
the transaction station is one of a plurality of transaction stations within the banking center;
the computer server is configured to receive a plurality of transactions that each require use of the shared cash recycler; and
the computer server configures the shared cash recycler to complete each of the plurality of transactions.

9. A currency distribution system at a banking center location, the system comprising:
a first ATM located in the banking center, the first ATM comprising a first currency dispenser;
a second ATM located in the banking center, the second ATM comprising a second currency dispenser:
wherein the system is configured to:
receive, from a customer, a request to withdraw currency from the first ATM;
determine an availability of the first currency dispenser within the first ATM;
when the first currency dispenser within the first ATM is operational, transfer currency from the first ATM to the customer using the first currency dispenser; and
when the first currency dispenser within the first ATM is malfunctioning:
determine an availability of the second currency dispenser within the second ATM;
direct the customer to the second ATM using the first ATM;
transfer currency from the second ATM to the customer using the second currency dispenser; and
using the second ATM, complete the request to withdraw currency received from the first ATM.

10. The currency distribution system of claim 9, wherein the system is further configured to:
receive, from the customer, a request to deposit a check at the first ATM;
determine an availability of a first deposit acceptor within the first ATM;
when the first deposit acceptor within the first ATM is operational, draw the check into the first ATM using the first deposit acceptor;
when the first deposit acceptor within the first ATM is malfunctioning:
determine an availability of a second deposit acceptor within the second ATM;
using the first ATM, direct the customer to the second ATM;
draw the check into the second ATM using the second deposit acceptor; and
using the second ATM, complete the request to deposit the check received from the first ATM.

11. The currency distribution system of claim 9, wherein the system is further configured to:
determine an availability of a first receipt printer within the first ATM;
when the first receipt printer within the first ATM is operational, print a transaction receipt using the first receipt printer;
when the first receipt printer within the first ATM is malfunctioning:
determine an availability of a second receipt printer within the second ATM;
direct the customer to the second ATM; and
print the transaction receipt using the second receipt printer.

12. The currency distribution system of claim 9, wherein the system is configured to provide access to the cash dispenser within the second ATM in response to authentication of the customer at the second ATM.

13. The banking system of claim 12, the system is further configured to transmit, to the second ATM, transaction information entered by the customer using the first ATM.

14. The currency distribution system of claim 12, wherein when the customer is a first customer, the system is further configured to:
detect a presence of a second customer at the second ATM before the first customer is authenticated at the second ATM;
determine an operational status of a third cash dispenser within a third ATM at the banking center;
using the first ATM direct the customer to the third ATM;
transfer the currency from the third ATM to the customer using the third cash dispenser; and
complete the request to withdraw currency received from the first ATM using the third ATM.

15. The currency distribution system of claim 9 wherein when the first cash dispenser within the first ATM is malfunctioning:
when the second ATM is within a five-foot radius of the first ATM, the system transfers the currency to the customer using the currency dispenser of the second ATM; and
when the second ATM is outside the five-foot radius of the first ATM, the system cancels the customer's request.

16. The currency distribution system of claim 9 wherein, when the first currency dispenser is malfunctioning, the system is configured to display instructions using the first ATM that direct the customer to the second ATM.

17. The currency distribution system of claim 9 wherein, when the first cash dispenser is malfunctioning, the system is configures the second ATM to display an invitation to the customer to use the second currency dispenser.

18. A method for disbursing currency within a banking center, the method comprising:
receiving a request for currency from a customer at a first ATM;
using the first ATM, determining whether a first currency dispenser within the first ATM is operational;
when the first currency dispenser is operational, dispensing the requested currency to the customer using the first currency dispenser;
when the first currency dispenser is malfunctioning, identifying a second ATM within the banking center;
using the first ATM:
directing the customer to the second ATM; and
transmitting the request for currency to the second ATM; and
using the second ATM, dispensing the requested currency to the customer using a second currency dispenser within the second ATM.

19. The method of claim 18 further comprising, using the second ATM, communicating an invitation to the customer to retrieve the requested currency from the second currency dispenser.

20. The method of claim 18 further comprising, in response to authentication of the customer at the second ATM, dispensing the requested currency to the customer using the second currency dispenser.
